(19) United States
(12) Patent Application Publication
(10) Pub. No.: US 2011/0159945 A1
(43) Pub. Date: Jun. 30, 2011

(54) GAMING SYSTEM AND METHOD WITH MULTI-SIDED PLAYING ELEMENTS

(76) Inventor: Amanda Jane Schofield, Lane Cove NSW (AU)

(21) Appl. No.: 12/982,298

(22) Filed: Dec. 30, 2010

Related U.S. Application Data
(63) Continuation of application No. 11/869,453, filed on Oct. 9, 2007, now abandoned.

(30) Foreign Application Priority Data
Oct. 6, 2006 (AU) 2006905597

(51) Int. Cl. A63F 13/00

(52) U.S. Cl. 463/20

(57) ABSTRACT

A method for a gaming machine is described that includes displaying a representation of at least one multi-sided playing element having a plurality of faces, and selecting, according to random criteria, a symbol for display on a first presented face of each multi-sided playing element. The selection may be made from a set of symbols that has more members than there are faces on the multi-sided playing element. Symbols on at least two and less than all of the presented faces of each multi-sided playing element may indicate a winning combination. The outcomes of the game may be defined from various sides of the one or more playing elements.

### RELATED APPLICATIONS

This application is a continuation of co-pending U.S. application Ser. No. 11/869,453, filed Oct. 9, 2007, which claims priority to Australian Patent Application No. 2006905597, having a filing date of Oct. 9, 2006, entitled “Gaming System and Method With Multi-Sided Playing Elements”, contents of which are hereby incorporated by reference herein in their entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to gaming systems and methods of gaming. A particular embodiment of the present invention relates to gaming machines implementing dice games.

With the increase of gambling at gaming venues has come increased competition between gaming venues to obtain a larger share of the total gambling spend. Gaming venue operators have therefore continuously looked for new variations and types of games in order to attract both new and return customers to their venues.

In response to this need, suppliers of gaming devices and systems have attempted to provide the sought after variety, while still developing games that comply with the relevant regulations in the jurisdiction of the gaming venue operator. Suppliers of gaming devices therefore are faced with restrictions on the types of games and gaming apparatus that are allowable, both in terms of the prevailing regulations and in terms of providing a return on investment to the gaming venue operators.

In addition, it is important that a player be able to understand the operation of a game quickly so that the player can start to quickly play the game and therefore extract maximum entertainment from the game.

Various types of gaming machines have been provided. One common type of gaming machine implements a spinning reel game. In games of this type a reel having a number of symbols is provided and spun, with the stopping position determined dependent on the output from a random number generator. Spinning reel games have a long history of success, starting with mechanical reels driven by electromechanical controllers and more recently including gaming machines with video displays on which representations of spinning reels are displayed.

Another common type of gaming machine implements a poker-style card game, in which a card from a deck is selected dependent on the output from a random number generator and displayed in a symbol position on a display. This process is repeated for a plurality of cards to form one or more hands or other outcomes that are evaluated for the occurrence of a winning outcome.

A third common type of gaming machine is a dice game, in which a plurality of dice are displayed on screen with the face of each dice displayed being determined dependent on the outcome of a random number generator. One or more outcomes are then defined by one or more combinations of dice, which are then evaluated for a winning outcome.

Each of the aforementioned types of games may have their own respective advantages and disadvantages in terms of player appeal, flexibility to game designers to provide a range of games, and development cost and time to market. Variations in player appeal may result in some players preferring a particular type of game, which may limit the number of gaming machines at a venue that a player can play. Variations in flexibility and development cost and time may also limit the range of games a gaming venue can economically provide its players. The player may therefore look to other gaming venues to find variations of gaming machines of their preferred type.

### BRIEF SUMMARY OF THE INVENTION

According to a first aspect, the invention broadly resides in a method for use with a gaming machine that is arranged to select symbols, present the selected symbols on a display and evaluate the selection for winning symbols or combinations, the method including:
displaying on a display a representation of at least one multi-sided playing element having a plurality of faces;
displaying images representing each said multi-sided playing element moving and then showing a representation of each said multi-sided playing element in a stopped position to present one or more of the plurality of faces; and
selecting, according to random criteria, a symbol for display on a first presented face of each multi-sided playing element, wherein the selection is made from a set of symbols that has more members than there are faces on the multi-sided playing element.

In one embodiment, the multi-sided playing elements have at least ten sides. The multi-sided playing elements may have between twenty and twenty-five sides.

In one embodiment, the process of selecting a symbol for display on the first face is biased so that for at least one symbol selection of that symbol for display on the first face is disproportionate to the number of distinct symbols in the symbol set.

In one embodiment, the method may further include:

determining another member from the set of symbols for display on a second presented face of each multi-sided playing element, the determination made so that the member on the second face is determined with a probability substantially proportional to the frequency of that member in the symbol set.

In an alternative embodiment, the method may further include:

determining another member from the set of symbols for display on a second presented face of each multi-sided playing element, the determination made so that the member on the second face is determined with a probability substantially equal to the probability of that member being selected for display on the first face.

According to a second aspect, the invention broadly resides in a method for use with a gaming machine that is arranged to select symbols, present the selected symbols on a display and evaluate the selection for winning symbols or combinations, the method including:
displaying on a display a representation of a plurality of multi-sided playing elements each having a plurality of faces, at least three faces being visually presented by the gaming machine;
selecting, according to random criteria, symbols for display on each of the three presented faces of each multi-sided playing element and displaying the selected symbols on their respective multi-sided playing element; and
evaluating symbols on at least two and less than all of the presented faces of each multi-sided playing element for the occurrence of a winning combination.

In one embodiment, at least one presented face is not used for the evaluation of the occurrence of a winning combination for every possible game option. The game options may include different wager options in which a player wagers an increased amount for an increased number of faces on each playing element to be used in the evaluation for a winning combination.

In one embodiment, the method includes providing a player with an option to substitute one or more of the multi-sided playing elements with a replacement multi-sided playing element that results in at least one of an increased probability of the occurrence of a winning outcome and the award of a larger value award on the occurrence of one or more winning combinations.

According to a third aspect, the invention broadly resides in a method for use with a gaming machine that is arranged to select symbols, present the selected symbols on a display and evaluate the selection for winning symbols or combinations, the method including:

displaying on a display a representation of a plurality of multi-sided playing elements each having a plurality of faces, at least three faces being visually presented by the gaming machine;

selecting, according to random criteria, symbols for display on each of the three presented faces of each multi-sided playing element and displaying the selected symbols on their respective multi-sided playing element;

following the display of the selected symbols on their respective multi-sided playing element rotating at least one multi-sided playing element so that the faces occupy different positions on the die and evaluating the symbols on the rotated multi-sided playing element for a winning symbol or combination.

In one embodiment, the method further includes providing the option to rotate the die in at least two directions. The method may further include providing the option to rotate the die in three directions. The number of directions that the die may be rotated may match the number of edges around each face of the multi-sided playing element. Therefore, the playing element may be rotated in one of r directions, wherein r equals the number of edges around each face of the multi-sided playing element. If the playing element has sides with a different number of faces, then r equals the number of edges on the uppermost playing element.

In one embodiment, the process of rotating is completed only if rotating the playing element would result in a winning combination associated with an award larger than any award associated with a winning combination that occurred before the process of rotating. The method may further include making this determination automatically and indicating to the player on the display the direction of rotation required to achieve the winning combination associated with the larger award.

According to a fourth aspect, the invention broadly resides in a method for use with a gaming machine that is arranged to select symbols, present the selected symbols on a display and evaluate the selection for a winning combination, the method including:

displaying on a display a representation of a plurality of multi-sided playing elements;

displaying a representation of each said multi-sided playing element moving and then showing a representation of each said multi-sided playing element in a stopped position to present a plurality of symbols, the symbols thereby presented being selected according to random criteria; and
forming one or more outcomes from a combination of one symbol presented by each of a plurality of the multi-sided playing elements for evaluation for the occurrence of a predefined winning combination of symbols, at least one said outcome including symbols from different faces of the multi-sided playing elements as viewed on the display.

In one embodiment, at least one of the plurality of multi-sided playing elements presents symbols used to form two or more different outcomes.

In one embodiment, at least one symbol presented by a said multi-sided playing element is used to form two or more different outcomes.

According to a fifth aspect, the invention broadly resides in a method for use with a gaming machine that is arranged to select symbols, present the selected symbols on a display and evaluate the selection for winning symbols or combinations, the method including:
displaying on a display a representation of at least one multi-sided playing element having a plurality of faces, at least a first face and a second face being visually presented by the gaming machine;

independently selecting, according to random criteria, a symbol for display on the first face and second face of each multi-sided playing; and
evaluating one or more outcomes as a combination of symbols presented by the at least one multi-sided playing element for a winning combination of symbols, at least one of said outcomes defined by symbols presented on the first and second faces of the same multi-sided playing element.

In one embodiment, at least one of said outcomes is defined entirely by symbols presented on the same multi-sided playing element.

According to a sixth aspect, the invention broadly resides in a method for use with a gaming machine that is arranged to select symbols, present the selected symbols on a display and evaluate the selection for a winning combination, the method including:

displaying on a display a representation of a plurality of multi-sided playing elements;
displaying a representation of each said multi-sided playing element moving and then showing a representation of each said multi-sided playing element in a stopped position to present a plurality of symbols, the symbols thereby presented being selected according to random criteria; and forming one or more outcomes from a combination of one symbol presented by each of plurality of the multi-sided playing elements in a predefined order for evaluation for the occurrence of a predefined winning combination of symbols;

wherein the predefined order is displayed on the display by indicia associated with each multi-sided playing element.

In one embodiment, the multi-sided playing element may be displayed with different colors and the indicia may be the color of the multi-sided playing element. Alternatively, the multi-sided playing element may be displayed with a number that includes the indicia. The color of the multi-sided playing element may affect the award that is paid.

According to a seventh aspect, the invention broadly resides in a method for use with a gaming machine that is arranged to select symbols, present the selected symbols on a display and evaluate the selection for a winning combination, the method including:
displaying on a display a representation of a plurality of multi-sided playing elements;
displaying a representation of each said multi-sided playing element moving and then showing a representation of each said multi-sided playing element in a stopped position to present a plurality of symbols, the symbols thereby presented being selected according to random criteria; and
forming one or more outcomes from a combination of one symbol presented by each of plurality of the multi-sided playing elements in a predefined order for evaluation for the occurrence of a predefined winning combination of symbols;
wherein the predefined order is indicated to the player on the display otherwise than in accordance with the relative position of the dice.

In one embodiment, the predefined order may be indicated by the order of moving of the dice.

In one embodiment, the location of display of the multi-sided playing elements varies between game plays.

According to an eighth aspect, the invention broadly resides in a gaming apparatus including a game controller in communication with a display and a user input device, the gaming apparatus operable to play a game in which symbols are selected and presented on a display and the selection is evaluated for winning symbols or combinations, the game controller operating in accordance with instructions stored in memory to implement the method as described in the immediately preceding paragraphs.

According to a ninth aspect, the invention broadly resides in instructions executable by a game controller to implement the method as described in the immediately preceding paragraphs and so such instructions when stored in a storage medium readable by the game controller.

Further aspects of the present invention will become apparent from the following description, given by way of example only and with reference to the accompanying drawings.

### BRIEF DESCRIPTION OF SEVERAL VIEWS OF THE DRAWINGS

The present invention will now be described, by way of example only, with reference to the accompanying drawings, in which:

FIG. 1: shows diagrammatically, a view of a gaming machine suitable for implementing certain embodiments of the present invention.

FIG. 2: shows a block diagram of gaming apparatus suitable for implementing certain embodiments of the present invention.

FIG. 3: shows a block diagram of components of the memory of the gaming apparatus represented in FIG. 2.

FIG. 4: shows a flow diagram of a process according to one embodiment of the present invention.

FIG. 5: shows diagrammatically, a multi-sided playing element that may be displayed in accordance with an embodiment of the present invention.

### DETAILED DESCRIPTION OF THE INVENTION

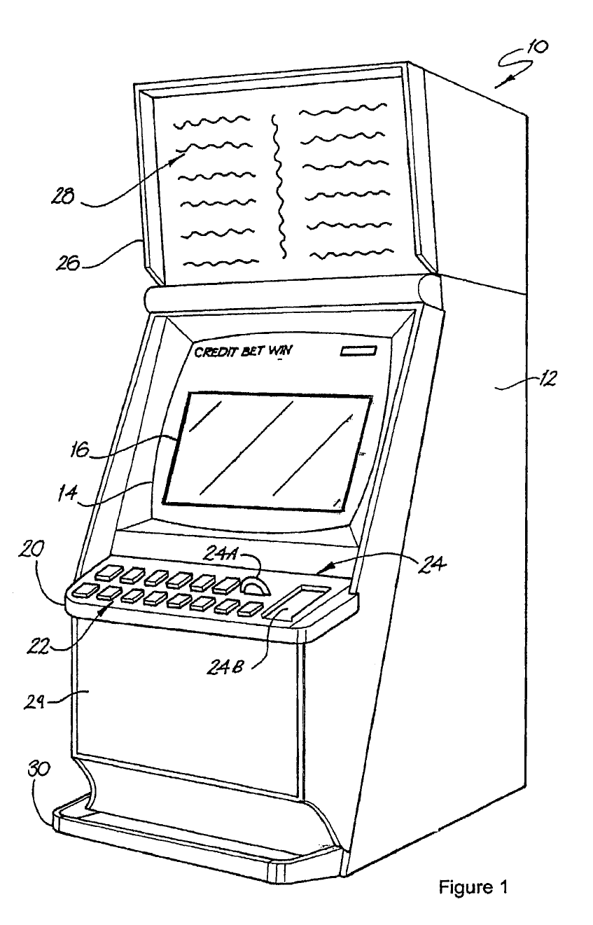

In FIG. 1 of the accompanying drawings, one example of a gaming machine suitable for implementing certain embodiments of the present invention is generally referenced by arrow 10.

The gaming machine 10 includes a console 12 having a display 14 on which is displayed representations of a game 16, that can be played by a player. A mid-trim 20 of the gaming machine 10 houses a bank of buttons 22 for enabling a player to play the game 16. The mid-trim 20 also houses a credit input mechanism 24 including a coin input chute 24A and a bill collector 24B. A top box 26 may carry artwork 28, including for example, pay tables and details of bonus awards and other information or images relating to the game. Further artwork and/or information may be provided on the front panel 29 of the console 12. A coin tray 30 is mounted beneath the console 12 for cash payouts from the gaming machine 10.

The display 14 shown in FIG. 1 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or a different type of display.

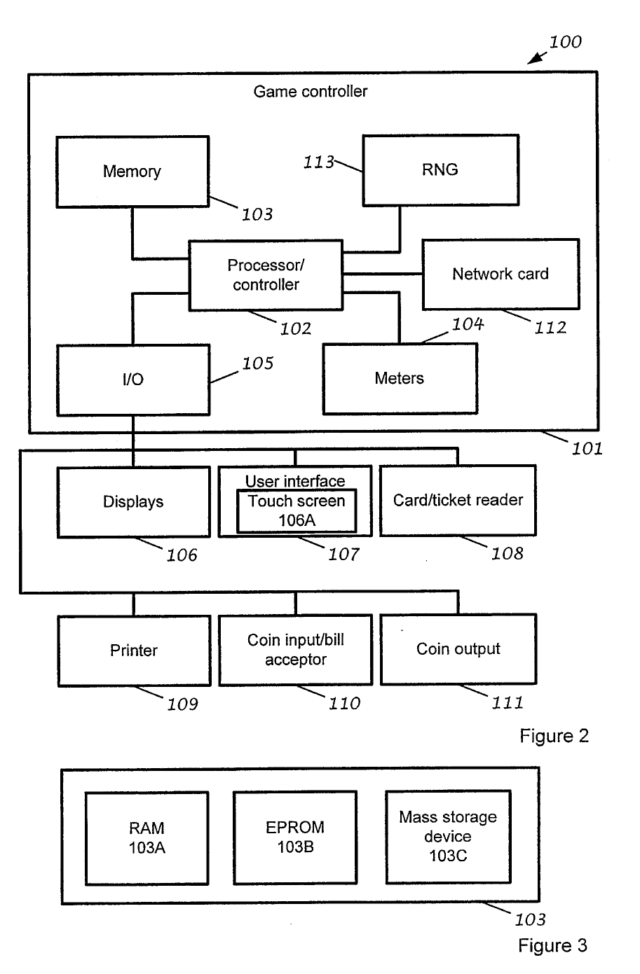

FIG. 2 shows a block diagram of a gaming apparatus, generally referenced by arrow 100, suitable for implementing certain embodiments of the present invention. The gaming machine 100 may, for example, operate as a standalone gaming machine of the type shown in FIG. 1. However, the gaming machine 100 may alternatively operate as a networked gaming machine, communicating with other network devices, such as one or more servers or other gaming machines. The gaming machine 100 may also have distributed hardware and software components that communicate with each other directly or through a network. Accordingly, different reference numerals have been used in FIG. 2 from FIG. 1 for components that may be equivalent.

The gaming machine 100 includes a game controller 101, which in the illustrated example includes a computational device 102, which may be a microprocessor, microcontroller, programmable logic device or other suitable device. Instructions and data to control operation of the computational device 102 are stored in a memory 103, which is in data communication with or in the case of a programmable logic device forming a part of the computational device 102. Typically, the gaming machine 100 will include both volatile and non-volatile memory and more than one of each type of memory, with such memories being collectively represented by the memory 103. The instructions to cause the game controller 101 to implement the present invention will be stored in the memory 103.

The gaming apparatus may include hardware meters 104 for the purposes of regulatory compliance and also include an input/output (I/O) interface 105 for communicating with the peripheral devices of the gaming machine 100. The input/output interface 105 and/or the peripheral devices may be intelligent devices with their own memory for instructions and data.

In the example shown in FIG. 2, the peripheral devices that communicate with the controller are one or more displays 106, user input devices 107, a card and/or ticket reader 108, a printer 109, a bill acceptor and/or coin input mechanism 110 and a coin output mechanism 111. One or more of the displays 106 may include a touch screen 106A, forming part of the user input devices 107. Additional devices may be included as part of the gaming machine 100, or devices omitted as required for the specific implementation.

In addition, the gaming machine 100 may include a communications interface, for example a network card 112. The network card, may for example, send status information, accounting information or other information to a central controller, server or database and receive data or commands from a the central controller, server or database. One or more of the peripheral devices, for example the card/ticket reader 108 may be able to communicate directly with the network card 112.

The game controller 101 may also include a random number generator 113, which generates a series of random numbers that determine the outcome of a series of random game events played as part of a game on the gaming machine 100. The computational device 102 may include two or more controllers or processors, which may be local or remote from each other and the displays 106.

FIG. 3 shows an exemplary block diagram of the main components of the memory 103. The RAM 103A typically temporarily holds program files for execution by the computational controller 102 and related data. The EPROM 103B may be a boot ROM device and/or may contain some system or game related code. The mass storage device 103C is typically used to store game programs, the integrity of which may be verified and/or authenticated by the computational controller 102 using protected code from the EPROM 1038 or elsewhere.

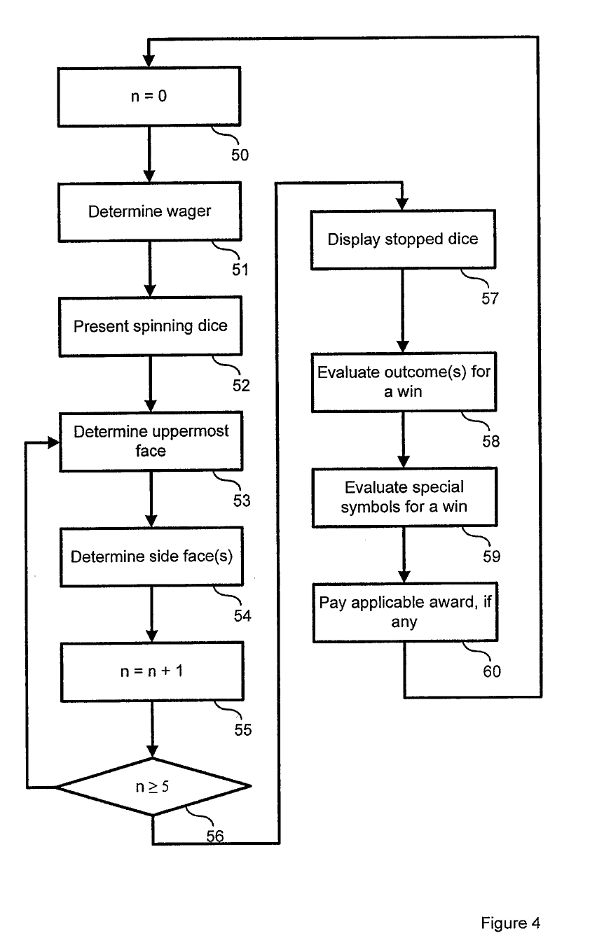

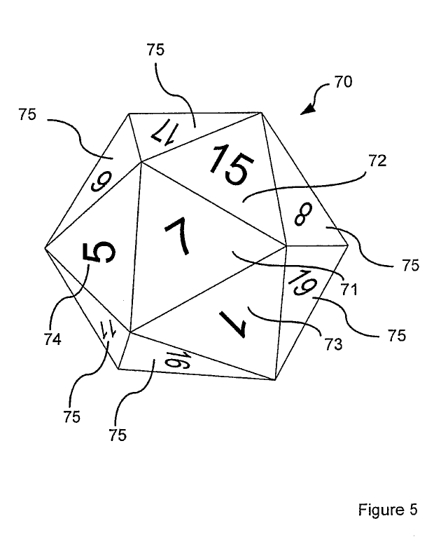

FIG. 4 shows a process flow diagram of a process performed in accordance with an embodiment of the present invention. The process may be performed by the gaming machine 100 and the following description assumes this implementation.

The process commences in step 50, in which a counter for the number of multi-sided playing elements used is initialised, in this example to zero. Throughout the remainder of the description, the multi-sided playing elements will be described as dice, although the present invention is not necessarily limited to multi-sided playing elements that would be recognisable as dice.

In step 51, the game controller 101 monitors the credit input/bill acceptor 110 and/or in the case of a networked gaming system communications received by the network card 112 for a deposit of credit and in response causes a software meter maintained by the game controller 101 in the RAM 103A to increment and also causes the hardware meters 104, if fitted to the gaming machine 100, to increment according to the denomination of the game. The game controller 101 then monitors the user interface 107, which may include the touch screen 106A for the input of a wager.

If there are sufficient credits in the meters 104 to support the wager, a game play is commenced in step 52 by the game controller 101 controlling a display 106 to display a representation of one or more moving dice. This representation of moving dice may include a representation of dice being thrown and translating across the display 106 (in which case the dice still spin), as well as spinning about one or two axes and remaining stationary. Each die may be shown to start and/or stop moving individually, or alternatively all dice may start to move and stop simultaneously. In an alternative embodiment the dice are not directly shown as moving and the game controller 101 cause the display of some other representations on the display 106 to indicate a game play.

In one embodiment, the representations of the dice may emulate the movement of a physical dice. For example, the path of each die across the display 106 may vary, to emulate a physical die bouncing on an edge. The path may be fixed, may randomly vary between a plurality of different possible paths, or may be determined randomly on a case by case basis.

Where the path is determined randomly on a case by case basis, the die may be determined to bounce a certain number of times and move in one of a plurality of possible directions following each bounce, the direction being randomly determined. The images on the display may reflect the direction of each bounce by showing an appropriate orientation of the die when the bounce occurs to emulate a physical die.

When each die has been spun, the game controller 101 may cause a display 106 to display an enlarged view of each die to increase the visibility of the outcomes that occurred in that game play.

The number of dice used in the game is selected by the game designer and could be as small as one die, or could be a large number of dice. However, use of between three and ten dice may be the most suitable for many implementations of embodiments of the invention. In the following example five dice have been selected, each presenting ten sides on the display 106 when shown in their stopped position so as to each appear to be a twenty-sided die.

An exemplary die of this type is shown in FIG. 5 and referenced by arrow 70. The die 70 is shown in its stopped position and presents an uppermost face 71, which has the symbol “7” displayed on it. Adjoining each of the three sides of the uppermost face 71 are three faces 72-74, which display the symbols “15”, “1,” and “5,” respectively. Six further faces 75 are visible and in one embodiment these faces will display further symbols, but in other embodiments these may be omitted.

Definitions of symbols for the faces of the die 70 are stored in the memory 103 with the game instructions. The symbols may be numbers and the present example uses numbers as the symbols. However, other indicia may be used for the symbols, including letters, dots like on a traditional physical die, or characters. Each die used in the game may be defined with the same symbols in the same or different proportions, or different dice may have different symbol sets. In addition, the dice may include two or more die with a different number of faces. For example one die may have 20 faces and another die 30 faces. The symbols that are available for selection to be presented on a face of each die 70 is a matter of game design and many possibilities exist.

In step 53, the game controller 101 receives a number from the RNG 113 and uses this number to determine which symbol to display on the uppermost face 71 of the first die 70. If the random number generator 113 generated a number between 0 and 999, then the numbers 0 to 49 may be allocated to a first symbol, numbers 50 to 99 allocated to a second symbol, numbers 100 to 149 allocated to a third symbol and so on, so that twenty symbols each have fifty numbers allocated to them. Alternatively, by varying the ranges allocated to each symbol the die may be biased so that some symbols can be expected to occur more often than others.

In another embodiment, more or less symbols may be defined for each die than there are faces of the die by appropriate design of the number ranges allocated to each symbol. For example, fifty symbols may be defined, which are allocated on average twenty numbers in the range 0 to 999. In another example, ten symbols may be defined and allocated on average one hundred numbers in the range 0 to 999.

In step 54, the side faces to be displayed are determined. The side faces to be displayed may be determined in a number of ways. In one embodiment, the determination is constrained by the probabilities of occurrence of the symbol on the uppermost face 71. For example, if the die has 20 faces, the uppermost face 71 is used to define winning outcomes and there were sixty symbols, three of which were “7”, then for an unbiased die, we would expect to see the “7” on the uppermost face in 20 games and on the adjoining 9 faces 9 times in 20 games. If the same die is used with the same symbols but the die is biased for the uppermost face such that the bias causes the “7” to be located on the uppermost face to 1 in 40 times, then we would see the “7” on the adjoining 9 faces, 19 times in 20 games. This would give the appearance of the “7” occurring the expected number of times on the viewable faces of the die, but only half the number of times on the uppermost paying position. This embodiment may be preferred in some circumstances due to the frequency of display of the symbols matching the actual probability of occurrence of the symbols on the faces that are evaluated for the occurrence of winning combinations.

This example may be achieved by allocating 120 “symbol positions” to the game, each symbol position having an equal probability of occurrence, and filling three of those symbol positions with “7” symbols. The remaining 59 symbols would be allocated to the 117 other symbol positions in proportion to their required probability of occurrence. Each symbol position may be given a position number and the output of the RNG 113 is used to select a position number. The symbol in the symbol position with that position number may then be selected for display on the uppermost face (step 53) and the symbols in the following nine symbol positions selected for display on the nine side faces (step 54).

Another method to achieve this example is to individually randomly determine the symbols to be displayed on each face according to a constant probability of occurrence for each face. This method may give results that the player may not expect in a dice game, for example multiple occurrences of the same symbol on different presented faces. Whether multiple occurrences of the same symbol can occur in any embodiment will depend on the objectives of the game designer.

It is therefore possible to define multiple different combinations of side faces that appear when a particular symbol is selected for display on the uppermost face 71. Referring to FIG. 5, in addition to being displayed with adjoining symbols “15”, “1” and “5”, symbol “7” may be displayed with a different set of adjoining symbols. Taking the example of three symbol positions being filled by “7” symbols, then each symbol position may be mapped to a different set of side symbols. This mapping can create a lack of randomness in the side symbols in a similar way that a spinning reel game that displays more than one symbol on a reel does not have randomness between adjacent symbols on the reel.

Where a different number of symbols is defined for each die than there are faces of the die, and/or there are multiple occurrences of symbols that map to different side symbols, the die may be designed with more than six faces (i.e. more than a traditional physical die). The more faces that are used, then the less likely it is that a player of the dice game will appreciate that there are more symbols or combinations associated with a symbol than there are faces of the die.

The use of more faces may result in an advantage of the player getting the feel of a dice game, but the game designer having a large amount of flexibility in designing the symbol sets, their frequency of occurrence, and the combinations of presented symbols that occur on the dice. This may also facilitate design of games where outcomes that are evaluated for winning combinations can span across a plurality of multi-sided playing elements in a number of different ways. For example one outcome may be defined by the symbols presented on the uppermost face 71 of five dice, another outcome may be defined by the symbols presented on face 72 of a first die, face 73 of a second die, face 72 of a third die and so on in a zig-zag pattern. The game rules, including the probabilities of occurrence of each winning combination and the awards for winning combinations may therefore be designed to be similar to a spinning reel game that has pay lines across a plurality of spinning reels. The awards may include credit payments, bonus games such as providing a series of free spins of the dice, non-cash prizes and other variations provided on existing spinning reel games.

As explained latter herein, a large number of outcomes could be defined using multi-sided playing elements that present multiple symbols. Where the side faces are individually randomly determined, then outcomes may be defined within a single die, for example six outcomes may be defined by using faces 71 to 74 and one of the faces 75. Where the order of the symbols is relevant for defining a winning combination, still further outcomes may be defined within a single die, with multiple outcomes using the same faces but in a different order.

In an embodiment, there may be at least ten sides to each multi-sided playing element, more preferably between about 20 and 30, even more preferably between about 20 and 25, which reflects the number of symbol positions on some mechanical spinning reel game machines. This may create a balance between creating a feel of a dice game but still giving the option to design dice that do not reflect physical dice and not presenting too many symbols or faces to the player.

In step 55, the counter n is incremented by one and in step 56 the counter value is compared with the threshold value, which in this example is five because the game is intended to played as a five dice game. The steps 53 to 55 therefore repeat five times, one for each dice, until the counter n equals five, with the game controller 101 storing in memory 103 the results of each cycle.

The process then proceeds to step 57 and representations of the stopping position of the dice are displayed on the display 106. The game controller stores in memory 103 a definition of at least one outcome that can be purchased by a player by making a particular wager in step 51. One outcome may be formed by the symbols selected for display on the five uppermost faces 71 of the dice 70. Another outcome may be the five symbols selected for presentation on the faces 74 of the dice 70. In a game with five dice 70, each of which presents ten faces, there are one hundred thousand possible outcomes. The player may be able to use the bank of buttons 22 to select outcomes to be purchased, for example using a button that increments the count of purchased outcomes and/or using a button selects a group of outcomes, for example 50 outcomes.

Step 51 may include an option to purchase a particular dice. For example, by placing an additional wager, for example of 5 credits, the player may purchase the substitute of one die with a replacement die that is associated with more winning combinations and/or higher paying winning combinations. For example, a replacement die may have an increased number of substitute symbols, which are sometimes referred to as WILD symbols. These symbols are provided in existing spinning reel games and when presented in a purchased pay line substitute for other symbols to form a winning combination. Therefore, in this example there are an increased number of winning combinations. Another symbol on the die may be a multiplier symbol, so that if that symbol forms part of a representation of a winning combination then the payout associated with that winning combination is multiplied.

In one embodiment, although ten faces are presented on each dice 70, only the uppermost face 71 and the side faces 72, 73 and 74 define game outcomes. Symbols may still be on the other faces 75, selected in accordance with a method described previously herein, but are not used to define game outcomes and therefore symbols could be omitted from the faces 75. In this embodiment, up to 1024 outcomes may be defined, when the dice are considered in a predetermined order and in one direction only. The outcomes may be defined in a similar way to paylines through a spinning reel game, except that instead of taking one symbol from each reel, the outcomes take one symbol from each die 70.

In one embodiment the gaming machine 100 may allow a player to operate the user interface 107 to purchase more than one group of dice. The dice may be thrown and displayed in a manner so that each of the groups of dice can be uniquely identified. Winning combinations may be displayed as particular symbols within each group.

Alternatively, where the option to purchase more than one group of dice is provided, the dice may be thrown or displayed so that the groups of dice can be interrelated to form patterns that represent winning combinations. For example, pay lines may be defined across groups of dice as well as through groups of dice, symbols may be from left to right, right to left, any adjacent symbol or any combination along a pay line that extends within a group and/or across groups, or patterns of symbols across groups may represent a prize in a similar way that a pattern of symbols in a bingo game represents a prize winning outcome.

If the outcomes are defined in this way, then an order of the dice 70 needs to be established and preferably communicated to the player. This may be achieved by locating the dice in a row (or multiple rows if provided in the particular implementation) so that the player can see that the outcomes are defined left to right across the dice in a row. The outcomes may also span across rows if the particular game design requires, this option presenting substantially more possible outcomes. Alternatively, the dice could be color coded, numbered or otherwise marked or indicated to show the order of the dice in forming an outcome. The dice could be represented on the display 106 as being “thrown” in sequence, which may be a fixed sequence or which may vary either under the control of the game controller 101 or under the control of a player of the gaming machine, for example by touching a touch screen over a representation of each die to indicate which should be ‘rolled’ next.

Alternatively, the game may pay according to poker style rules, where the order of the symbols on the dice 70 does not matter. For example, if there are five dice 70, one award may be paid on the occurrence of three “7” symbols on the uppermost face 71, regardless of which dice the symbols occur on.

Accordingly, the game controller 101 may control the representations of the dice 70 to appear anywhere on the display 106 relative to each other. The positions may be constant between game plays, or vary between game plays according to a predetermined pattern, or randomly. This is in contrast to spinning reel type games, poker style card games and many other dice games where the playing elements are displayed in fixed relative locations in order to communicate to the player how the outcomes are formed.

In step 58, the game controller 101 also evaluates the outcomes of the game play that have been purchased by the wager determined to have been made in step 51 for the occurrence of a winning outcome. Typically, if a winning outcome has occurred, the game controller 101 will cause the display 106 to indicate the symbols that form each winning outcome. If applicable to the particular game, the game controller 101 will also evaluate the symbols that have been selected for presentation on the dice 70 for “scatter symbols”, which may pay a prize regardless of whether they appear in any particular outcome. In the embodiment where only some of the presented faces are used to define the game outcomes, for example faces 71 to 74 of dice 70, then the scatter symbols may have to appear on one of those faces before they can result in an award. Alternatively, the scatter symbols may appear on any of the presented faces 71 to 75.

Other special symbols may be included in the symbols sets for one or more of the dice 70, including substitute symbols, bonus symbols that pay a prize on a single occurrence, symbols that trigger a feature game, multiplier symbols, symbols that are accumulated and which result in an award once a certain number have been collected. Also, the game may provide the option to “nudge” the dice to form a winning outcome or a higher paying winning outcome or combination of outcomes. An embodiment with a nudge feature may be suitably implemented using the dice 70 which show symbols on all ten presented faces 71-75, but use only faces 71-74, or use only face 71, when evaluating the selected symbols for winning outcomes. The nudge feature may operate to nudge the dice three or more directions. For example, the dice 70 shown in FIG. 5 may be nudged in three directions so that one of the faces 72 to 74 becomes the uppermost face. In this embodiment, it may be preferable to have dice where each face has an equal number of edges (3 in the example dice 70), so that the number of adjacent faces to the uppermost face remains constant.

The nudging of the dice may be only completed if rotating the dice would result in the award of a larger award (including the award of an award when none would be payable if the dice were evaluated in their current position). The game controller 101 may determine in which direction to nudge the dice if more than one direction is possible according to the direction that results in the award of the highest value award. The game controller 101 may indicate on the display 106, for example by way of an arrow presented over each die 70 to be rotated, indicating the required rotation to achieve the largest award. The player may be prompted to initiate the nudge by pressing a button in the user interface 107, and/or the nudge may automatically occur after a preset time has elapsed.

Eligibility for features such as the ability to nudge dice, or enter a feature game may be permanently available for any game play, may require a minimum wager, or require the placing of an ante-bet.

If one or more of the purchased outcomes define a winning outcome, or a special symbol or combination of special symbols results in a win, the game controller 101 will also look up a pay table defined in memory 103 and increment a win meter with the amount of credits associated with the winning outcome in the pay table. Feature games or other game variations such as a “double or nothing” option may be implemented following the spinning of the dice 70. The game controller will then cause the credit meter 104 to be incremented in accordance with the final win, if any (step 60).

In another embodiment the determination of the symbols displayed on the faces other than the uppermost face of the die 70 may be constrained by the probabilities that a player would expect to see if they knew the proportion that each symbol makes up in the symbol set, without regard to any bias towards certain symbols in the set. For example, if there were sixty symbols in a symbol set and three of those were the symbol “18”, then on the die 70, which displays nine side faces, then over 1000 games an “18” should appear on one of the nine side faces 72-75 about 450 times.

In another embodiment, there may not be an uppermost face of the die 70 when it is represented in its stopped position. Instead, the apex 76 may be the centrally displayed point of the die 70, in which case five faces would be presented around the apex 76. The selection of each face may be individually made, or one face designated as a first face and the remaining faces selected in accordance with the method previously described herein as if the first face was the uppermost face. All the faces may be able to be used in the evaluation for winning symbols or combinations, or alternatively a subset may be used, which may be dependent on the wager size. Where a subset is used, the selection of which face to use may be fixed, or may be randomly determined for each game play as another game step, which would occur between steps 57 and 58 in the process shown in FIG. 4.

Embodiments of the game described herein as implemented by a gaming machine 100 may also be implemented using physical dice. The dice may be evaluated by sight for winning combinations or using a scanning technique, for example a table that detects which face is facing downwards and accordingly which faces are showing upwards.

While the foregoing description has been provided by way of example of certain embodiments of the present invention as presently contemplated, which utilise gaming apparatus and machines, those skilled in the relevant arts will appreciate that the present invention also may have application to internet gaming and/or have application to gaming over a telecommunications network, where handsets are used to display game outcomes and receive player inputs.

Where in the foregoing description reference has been made to integers having known equivalents, then those equivalents are hereby incorporated herein as if individually set forth.

Those skilled in the relevant arts will appreciate that modifications and additions to the embodiments of the present invention may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

1. A method for use with a gaming machine including a display and a controller, the method including:
displaying on a display a multi-sided playing element having a plurality of faces;
displaying on said display a spinning of each said multi-sided playing element;
randomly mapping via a controller said faces to a symbol set having more symbol than a number of said faces;
randomly selecting via said controller a symbol from said symbol set;
displaying on said display each said multi-sided playing element spinning to a stop thereby displaying on an uppermost face of said multi-sided playing element a symbol mapped according to said selection;
randomly selecting via said controller another symbol from said symbol set; and
displaying another face adjoining said uppermost face of said multi-sided playing element another symbol mapped according to said selection of said another symbol.

2. The method of claim 1, wherein each said multi-sided playing element has ten faces.

3. The method of claim 1, wherein said mapping is biased, wherein a probability of mapping a face to a symbol is different from another probability of mapping another face to another symbol.

4. The method of claim 1, further comprising determining said another symbol from the symbol set so that the said another symbol is determined with a probability substantially proportional to a frequency of the said another symbol in the symbol set.

5. The method of claim 1, further comprising said another symbol from the symbol set so that the said another symbol is determined with a probability substantially equal to the probability of the said another symbol being selected for display on said uppermost face.
